(19) United States
(12) Patent Application Publication
(10) Pub. No.: US 2003/0151206 A1
(43) Pub. Date: Aug. 14, 2003

(54) Method, apparatus and system for creating a brush seal

(76) Inventor: Walter J. Smith, Ballston Spa, NY (US)

Correspondence Address: Wayne F. Reinke, Esq., Heslin Rothenberg Farley & Mesiti P.C., 5 Columbia Circle, Albany, NY, 12203-5160, US

(21) Appl. No.: 09/999,664

(22) Filed: Oct. 25, 2001

(51) Int. Cl. F16J 15/44; F01D 11/02

(52) U.S. Cl. 277/355; 156/72; 156/578

(57) ABSTRACT

A brush seal is created between two members, one of which may rotate with respect to the other. A bonding agent is applied to one or both members, each of which may include a groove for application of the bonding agent. Flexible filaments are then embedded into the bonding agent by, for example, electrostatic flocking. After the bonding agent hardens or cures, the brush seal is created.

### BACKGROUND OF THE INVENTION

1. Technical Field

The present invention generally relates to brush seals. More particularly, the present invention relates to the creation of brush seals by embedding flexible filaments into a bonding agent.

2. Background Information

In the past, large rotating element machines, such as, for example, turbines, incorporated labyrinth seals to reduce losses between high and low pressure areas, resulting in increased efficiency for the machine. As one skilled in the art will know, labyrinth seals comprise spaced hard “teeth” projecting out from, e.g., a stationary or rotating element, and almost touching the corresponding rotating or stationary member when at rest. During start up, the teeth would often contact the corresponding member, due to thermal expansion rate differences leading to radial and axial growth disparities between stationary and rotating members, causing damage to that member and/or the teeth. Further damage is possible, due to vibration when critical speeds are reached. This damage would lead to leakage rate increases, and, hence, efficiency losses. This problem was addressed by providing additional space between the teeth and the corresponding member. However, this too reduced efficiency, since it left a larger gap between the teeth and corresponding member during operation.

Further improvements to the basic labyrinth structure included the addition of an erodible element on the member opposite the teeth. This allowed the teeth to wear away the element without physical damage to the corresponding member or the teeth during startup. Although the resulting gap was smaller than prior to the inclusion of the element, there was still an unacceptable efficiency loss. This led to the use of brushes with flexible filaments that would bend during start up. These flexible filaments produced the smallest gap yet during normal operation.

Presently, the flexible filaments are cut longer than ultimately needed, taking into account post-manufacturing trimming. In addition, the filaments are manually stacked in some fashion. Typically, the filaments are welded between two metal rings, referred to as “sealing rings.” However, up to two thirds of the space needed for the brush seal can be used by the rings. The space needed for the sealing rings is, thus, a limiting factor to the available seal width (an industry term referring to the physical width of the filaments between the traditionally present sealing rings). The process of compressing the sealing rings and the filaments together for welding and cutting the filaments to length is also labor intensive.

Thus, a need exists for a way to increase the available seal width, and, therefore, increase efficiency.

### SUMMARY OF THE INVENTION

Briefly, the present invention satisfies the need for a way to increase the available seal width in a brush seal by replacing the sealing-ring arrangement with a bonding agent and flexible filaments embedded into the bonding agent. This allows for a much larger seal width, and improved turbo machinery efficiency, at a lower cost. The pressure on each filament reduces as the overall width of the seal increases, allowing sealing at higher pressure differentials.

In accordance with the above, it is an object of the present invention to provide a brush seal with a larger seal width than currently available for a given geometry.

The present invention provides, in a first aspect, a method of creating a brush seal. The method comprises applying a bonding agent to at least one member, either stationary or rotating, and embedding a plurality of flexible filaments into the bonding agent to create the brush seal.

The present invention also provides, in a second aspect, a brush seal comprising at least one member, a bonding agent on a surface of the at least one member, and a plurality of flexible filaments embedded in the bonding agent. There is an absence of sealing rings coupling the plurality of flexible filaments to the at least one member.

The present invention further provides, in a third aspect, a system for creating a brush seal. The system comprises a bonding agent for applying to at least one member, a plurality of flexible filaments, and a machine for embedding the plurality of flexible filaments into the bonding agent to create the brush seal.

The present invention also provides, in a fourth aspect, a brush seal flexible filament having a cross-sectional shape with a flow resistance coefficient higher than that of a circular cross-sectional shape.

The present invention further provides, in a fifth aspect, a brush seal flexible filament having a non-circular cross-sectional shape.

The present invention also provides, in a sixth aspect, a brush seal flexible filament having a cross-sectional shape with at least one of a corner, an included angle, a flat surface and a concave surface.

The present invention further provides, in a seventh aspect, a brush seal flexible filament having a cross-sectional shape allowing more eddy currents to form therearound as compared to circular cross-sectional shape.

The present invention further provides, in another aspect, a brush seal flexible filament having a cross-sectional shape with a flow resistance coefficient higher than that of a circular cross-sectional shape.

The present invention provides, in yet another aspect, a brush seal flexible filament having a cross-sectional shape with at least one of a corner, and included angle, a flat surface and a concave surface.

The present invention provides, in still a further aspect, a brush seal flexible filament having a cross-sectional shape allowing more eddy currents to form therearound as compared to a circular cross-sectional shape.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 depicts a bonding agent being applied within a groove of a member.

FIG. 2 depicts the member of FIG. 1 with flexible filaments electrostatically flocked into the bonding agent.

FIG. 3 depicts the member of FIG. 2 with the flexible filaments being angled.

FIGS. 4-12 depict example embodiments of brush seals in accordance with the present invention.

FIGS. 13-14 depict examples of cross-sectional shapes of brush seal flexible filaments in accordance with the present invention.

FIG. 15 is a graph of porosity versus loss coefficient for a flexible filament example arrangement.

### DETAILED DESCRIPTION OF THE INVENTION

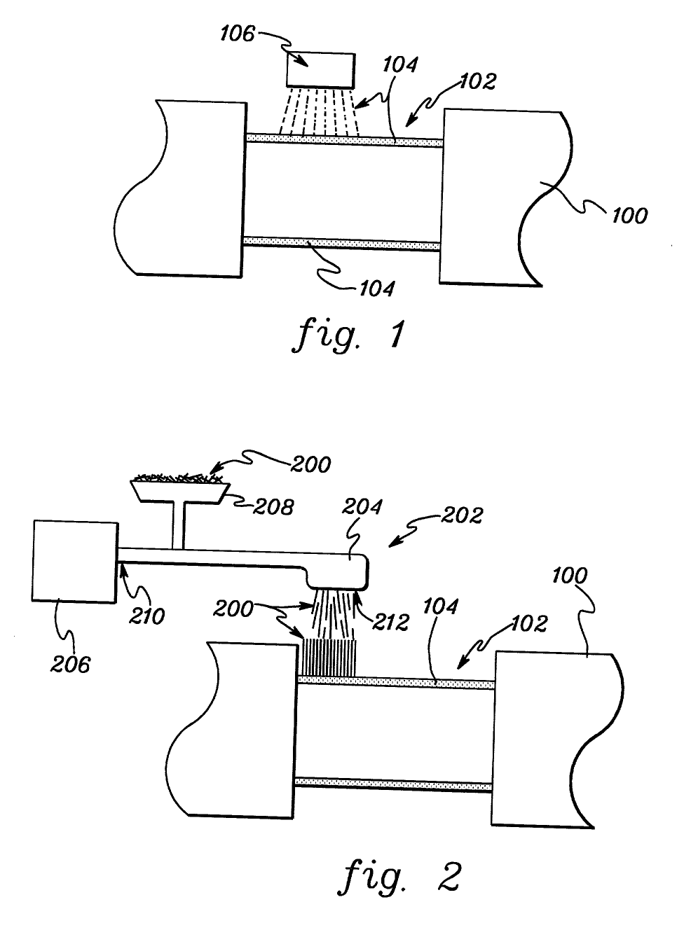

A method of creating a brush seal will now be described with reference to an example depicted in FIGS. 1-3. FIG. 1 depicts a cylindrical member 100 with a groove 102 machined therein. Cylindrical member 100 is, for example, a rotor of, for example, a turbine. Groove 102 is, for example, about 0.2 inches deep, and is machined using, for example, a lathe. A bonding agent 104 is evenly applied to the grooved area via spray applicator 106, while cylindrical member 100 is slowly rotated such that the bonding agent remains evenly distributed and does not drip off. Spray applicator 106 is, for example, an automated spray applicator, similar to that used for conformal coating of electronic components. Bonding agent 104 is, for example, a molten ceramic or molten metal material, such as, for example, a high temperature braise. Where there are areas that adherence of the bonding agent is not desired, a “stop-off” material can be applied prior to the bonding agent application. As one skilled in the art will know, a “stop-off” material is used to keep certain areas from being wetted by a braise and, therefore, not allowing the braise to adhere to the surface of interest. A stop off material is useful, for example, when an area of the groove is sought to be left without any brush seal filaments.

In the present example, bonding agent 104 is preferably evenly distributed over the surface of groove 102. However, it will be understood that the bonding agent could be unevenly distributed as well. In addition, it will be understood that the groove is not necessary for the basic invention. The bonding agent can be applied to any surface of a member. One limitation on the bonding agent for hot applications is that it must have a remelt point above the running temperature for the brush seal. In addition, it may be necessary in a given application to reduce capillary action between filaments. This can be done by, for example, choosing a bonding agent with a higher surface tension or by incorporating an additive to the bonding agent, or adding a thin layer of, for example, talc to the surface of the bonding agent prior to the application of the filaments. It will also be understood that spray applicator 106 could be manually controlled, or instead be a brush or other type of applicator. Further, cylindrical member 100 need not be rotated during bonding agent application; instead, the applicator could be manipulated (e.g., rotated) about the groove.

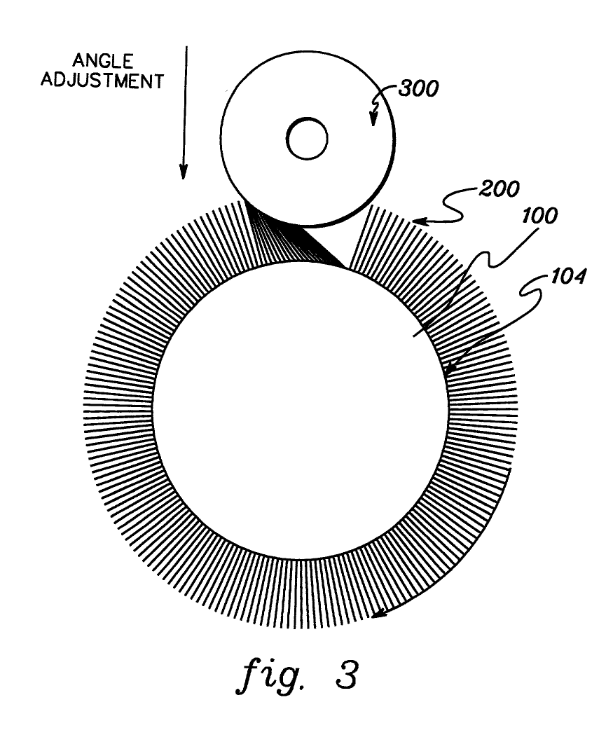

FIG. 2 depicts the cylindrical member 100 of FIG. 1 after the application of bonding agent 104 to groove 102. As shown, a plurality of flexible filaments 200 are being embedded (in this example, electrostatically flocked) into the bonding agent via flocking apparatus 202. The filaments are flexible so that during start-up, there is some “give” in the face of thermal expansion disparities, as well as running through critical speeds during startup. The flocking is done while cylindrical member 100 is slowly rotated, or, alternatively, while cylindrical member 100 remains in place and flocking apparatus 202 is manipulated about the groove. Flocking apparatus 202 comprises, for example, flocking gun 204, compressor 206, and hopper 208 to hold flexible filaments 200. The flexible filaments could be precut or cut to size after application. The compressor at one end 210 of gun 204 allows the filaments to be drawn out of hopper 208 and “shot” into bonding agent 104 at the other end 212. The flocking process can be automated or manual. In this manner, a brush seal is created with a longer seal width for a given geometry, and expressly without the need for sealing rings to stack to filaments and weld to the member. With a longer seal width, the filaments can also be smaller in cross-section, which reduces friction and improves flexibility. This can provide a more flexible seal with minimal wear of the filaments and mating seal surface.

Although compressor 206 assists in propelling filaments 200 into bonding agent 104, an electrical potential difference also does. Flocking gun 204 is kept at a positive or negative potential, AC or DC, while cylindrical member 100 is kept at a negative or positive potential (i.e., reverse polarity from the flocking gun), which causes filaments 200 exiting gun 204 at end 212 to be attracted to the cylindrical member. Further, the potential difference will also cause the filaments to align perpendicular to the surface into which they are shot, or, in this case, perpendicular to the normal of the surface where curved. The potential difference is, for example, about 15,000 volts DC.

It will be understood that although the embedding of the flexible filaments is described in this example as being accomplished by electrostatic flocking, the embedding could be done in other ways. For example, the flexible filaments could be placed, manually or mechanically (i.e., with a machine other than a flocking machine), into the bonding agent.

Flexible filaments 200 are made of, for example, a cobalt-based alloy (e.g., HAYNES 25 or other metal alloys), ceramic fiber, carbon fiber, or polyimide, and preferably cut to length or slightly longer to allow for some degree of wearing from friction. However, where the filaments are made of metal or any other material that is electrically conductive, they can begin to stick together upon exiting the flocking gun (or before) if left alone. Thus, the conducting filaments are preferably coated with an electrical insulator, such as, for example, a metal oxide or metal nitride, so long as the melting point of the insulator is higher than that of the bonding agent for hot applications. The target electrical resistance for the filaments is typically about b 10⁸ ohms for DC current, and about 10⁹-10¹⁰ ohms for AC current. Thus, in general, whatever material is chosen for the filaments, their electrical resistance may need to be altered, by, for example, adding an insulating coating or adding a conductive coating. The coating could be applied in a number of ways. For example, the metal filaments could be placed in a fluidized bed of the insulator material and removed, so as to fully coat them, or the insulator material could be applied to the filament stock before it is cut to length. The addition of the electrical insulator does, of course, change the stiffness and cross-sectional size of the filaments, which would need to be considered when the filaments are being designed for the particular purpose.

In cold applications, i.e., where the brush seal will not be exposed to high temperatures during use, for example, above 350° F., the bonding agent need not be hot during the application thereof, or during the flocking process. In such applications, bonding agents such as, for example, epoxies and rubber adhesives could be used. Where the filament material is non-conductive or otherwise has a high electrical resistance, it may be necessary to add a conductor such as, for example, a conductive powder or wash, to provide the basis for electrostatic flocking. The flexible filaments can be any of the materials that could be used for the high temperature process, as well as other materials with lower melting points, for example, cotton, rayon or nylon.

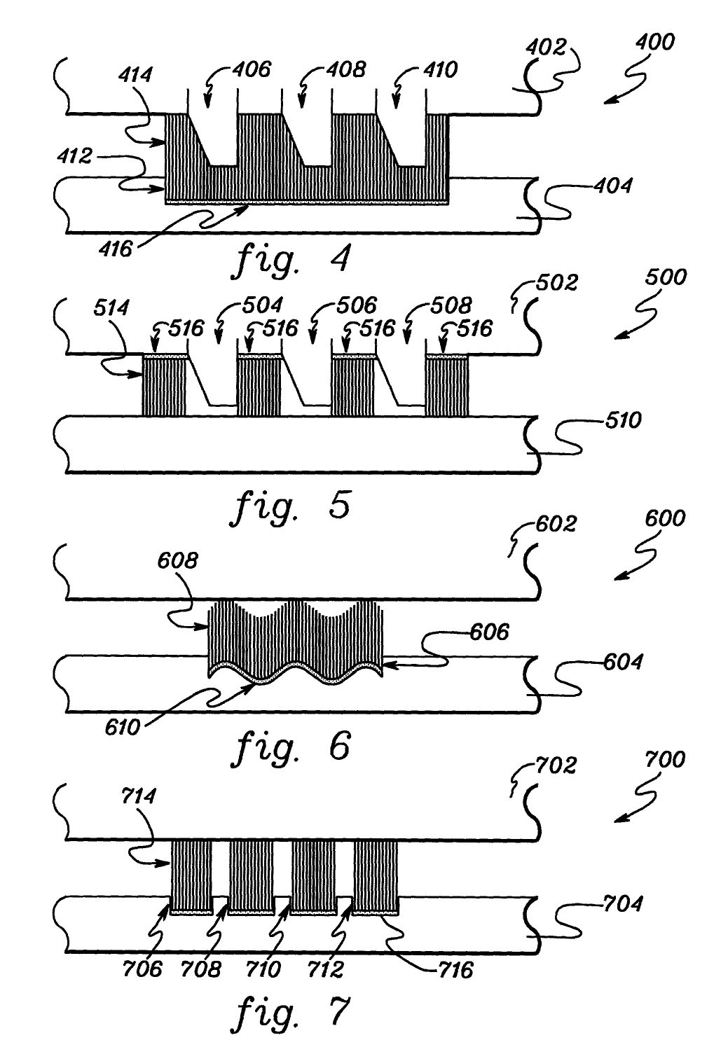

As noted above, the electrostatic flocking process results in the flexible filaments being aligned perpendicular to the surface coated with the bonding agent. For some applications, it may be desired that the flexible filaments be angled, rather than perpendicular, to the surface or normal of the member. FIG. 3 depicts a side view of cylindrical element 100 after flexible filaments 200 have been electrostatically flocked into bonding agent 104 before it hardens by cooling, chemical reaction or drying. Angle adjustment tool 300 is brought into contact with flexible filaments 200, and is simply a surface with which filaments 200 come into contact during rotation with respect to cylindrical element 100 such that the angle thereof changes to a desired angle. In the present example, angle adjustment tool 300 is simply a shaft with a smooth face that is brought into contact with the flexible filaments prior to hardening of the bonding agent. For example, although opinions differ on the issue, filament angles for turbines are currently thought to be nominally best at about 45 degrees with respect to the normal of the surface. Alternatively, angle adjustment tool 300 could have, for example, a grooved, toothed or other uneven face such that not all of the filaments become angled, some are angled to a lesser or greater extent, or the filaments are held in position in the axial direction while being tipped in the circumferential direction, which controls the axial spread of the filament tips.

In both hot and cold applications involving cylindrical members, for example, the members must be kept rotating until the bonding agent cures to ensure even application. Of course, it will be understood that the electrostatic flocking process can also be performed on a flat surface without rotation.

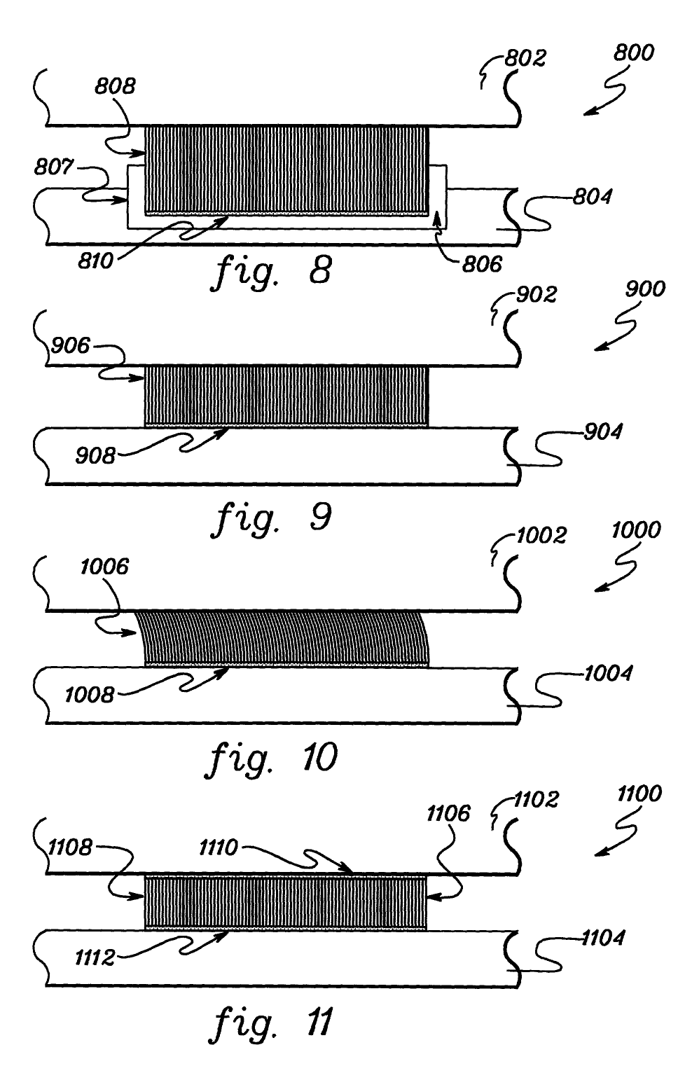

FIGS. 4 through 11 present examples of alternative embodiments for the brush seal of the present invention. FIG. 4 depicts a retrofitted labyrinth seal 400, comprising a first member 402 and a second member 404. One of members 402 and 404 rotates relative to the other. In the example of FIG. 4, labyrinth teeth 406, 408 and 410 extend out of member 402 toward member 404. The labyrinth teeth are inflexible metal. Member 404 comprises a groove 412 in which flexible filaments 414 have been electrostatically flocked into a bonding agent 416 applied thereto. However, it will be understood that groove 412 is optional. The filaments coinciding with the locations of the labyrinth teeth have been sized appropriately. However, the filaments could also be one length, allowing for trimming via friction during use. In this manner, a labyrinth seal can be retrofitted to include the brush seal of the present invention, while not removing the labyrinth teeth.

FIG. 5 depicts another embodiment of a retrofitted labyrinth brush seal 500. Like seal 400, seal 500 has a member 502 with labyrinth teeth 504, 506 and 508 extending therefrom toward another member 510. One of members 502 and 510 rotates relative to the other. Flexible filaments 514 have been electrostatically flocked into a bonding agent 516 at the base of the labyrinth teeth. Thus, seal 500 is similar to seal 400, except that the flexible filaments are retrofitted onto the same member as incorporates the labyrinth teeth and there is no groove into which the filaments are electrostatically flocked. It will be understood, however, that seal 500 could include grooves for the filaments. In addition, the labyrinth teeth of seal 500 act as backers for the flexible filaments to prevent them from bending over due to a pressure drop.

FIG. 6 depicts another embodiment of a brush seal 600 in accordance with the present invention. The brush seal is made between members 602 and 604, one of which rotates with respect to the other. Member 604 comprises groove 606 having various groove depths thereacross. Flexible filaments 608 have been electrostatically flocked into a bonding agent 610 within groove 606. The varying depths of groove 606 allow flexible filaments of the same length to extend different distances between members 602 and 604. It may be desired in some applications not to have all of the flexible filaments extending the same distance toward the corresponding member, for example, to reduce friction at start up and give pressure drop advantages similar to a labyrinth configuration. An alternative to FIG. 6 that also produces the different filament distances is actually cutting the filaments to the various desired lengths after the bonding agent hardens.

FIG. 7 depicts still another embodiment of a brush seal 700 in accordance with the present invention. Brush seal 700 is made between members 702 and 704, one of which rotates with respect to the other, with member 704 including multiple independent grooves 706, 708, 710 and 712. Each groove comprises flexible filaments, such as flexible filaments 714 in groove 706, that have been electrostatically flocked into a bonding agent applied within the groove, e.g., bonding agent 716 in groove 712. The design of brush seal 700 allows for flexible filaments of all the same length with spaces in between groups of filaments. In addition, one edge of each groove will act as a backer, as explained with regard to FIG. 5. Further, it will be understood that the grooves are optional, and the bonding agent could be applied directly to the surface of member 704.

FIG. 8 depicts yet another example of a brush seal 800 between members 802 and 804, one of which rotates with respect to the other. Member 804 includes a separate member 806 (in this case, a ring) placed within a groove 807 of member 804. Member 806 includes flexible filaments 808 electrostatically flocked into a bonding agent 810. One side wall of member 806 will act as a backer for the flexible filaments. Since member 806 is separate from member 804, it allows the electrostatic flocking to be done prior to the coupling of member 806 and member 804. In some cases, however, member 806 may need to be attached to member 804 in two or more segments, for example, if it is a ring being put on the inside diameter of a turbine member. In addition, if the flexible filaments will be angled, it may also be advisable to angle the ring cut to correspond with the angle of the filaments, preventing a gap therein. In one scenario, member 806 comprises metal, as does member 804, and member 806 is welded into member 804. In an alternate embodiment, member 806 has no side walls, in which case a side wall of groove 807 would act as the backer.

FIG. 9 depicts still another example of a brush seal 900 between members 902 and 904, one of which rotates with respect to the other. Member 904 includes flexible filaments 906 electrostatically flocked into a bonding agent 908 on the surface of member 904.

FIG. 10 depicts another brush seal 1000 at startup between members 1002 and 1004, one of which rotates with respect to the other. Member 1004 includes flexible filaments 1006 electrostatically flocked into a bonding agent 1008 on the surface of member 1004. As shown, filaments 1006 are longer than necessary and have a slight bend. This is due to and addresses thermal expansion that can occur in some systems (e.g., gas turbines) after the startup period, at which time members 1002 and 1004 move away from each other. In another scenario without thermal expansion, or to a lesser extent, excess length of the flexible filaments simply wears away over time leaving a zero tip clearance.

FIG. 11 depicts yet another example of a brush seal 1100 between members 1102 and 1104, which are generally stationary with respect to each other, except for some relative movement due to uneven thermal expansion (e.g., a seal in a combustor). Each of members 1102 and 1104 includes a plurality of flexible filaments (i. e., filaments 1106 for member 1102, and filaments 1108 for member 1104) electrostatic flocked into a bonding agent 1110 and 1112, respectively, applied thereto.

FIG. 12 depicts still another example of a brush seal 1200 between members 1202 and 1204, which are generally stationary with respect to each other, except for some relative movement due to uneven thermal expansion (e.g., a seal in a combustor). Member 1204 includes flexible filaments 1206 electrostatically flocked into a bonding agent 1208 on the surface of member 1204. As shown, filaments 1206 are longer than necessary and have a slight bend. This is to accommodate the relative movement from uneven thermal expansion.

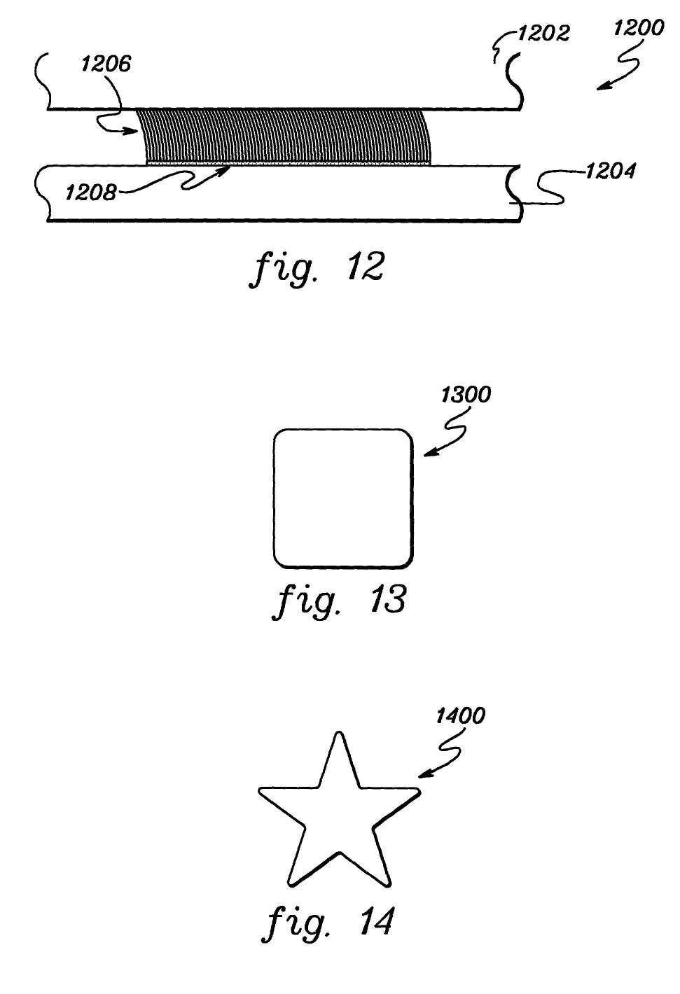

The efficiency of a brush seal is affected by the cross-sectional shape of the individual filaments. In general, any cross-sectional filament shape with corners, included angles, flat surfaces and/or concave surfaces (i.e., non-circular) is better for reducing air or fluid flow around the filament than a circular cross-section, because more eddy currents form around the filaments. Examples of such non-circular, cross-sectional shapes include a square (1300, FIG. 13) and a star (1400, FIG. 14). Note, however, that the corners should not be so sharp as to cause abrasion between adjacent filaments. Thus, the angles of the non-circular cross-section are also preferably rounded or blunted, which may actually happen naturally during the process of making the filaments. For example, where the filaments are extruded and stretched, any corners may be rounded during the process. Note that random orientation of the filaments relative to each other will occur in the flocking process, and may also help reduce flow. However, where density is an issue and the random orientation is of concern, any loss in density as compared to a sealing ring can be compensated for by careful selection of the filament shape. In fact, the careful selection of a filament shape alone will increase efficiency even on an existing sealing ring structure.

Although the flow resistance coefficient for the filaments varies, depending on pack density and individual fiber size, in general the flow resistance coefficient (also referred to as “drag coefficient”) is lowest for a circular cross-sectional filament. For example, assuming a single row of filaments, each having a diameter of about 0.004-0.007 inches, and a 300 psi pressure drop across the row, filaments in a row having a square cross-sectional shape will have as much as about a 75% lower flow rate (i.e., higher flow resistance coefficient) than a row with circular cross-sectional filaments. See, e.g., Robert D. Blevins, “Applied Fluid Dynamics Handbook,” page 314, Van Nostrand Reinhold Company, 1984. Put differently, a square cross-sectional filament shape is roughly as much as five times better than a circular shape with respect to limiting flow across the pressure drop. Thus, changing the shape of the filament or choosing a filament with a particular shape alone can greatly improve efficiency.

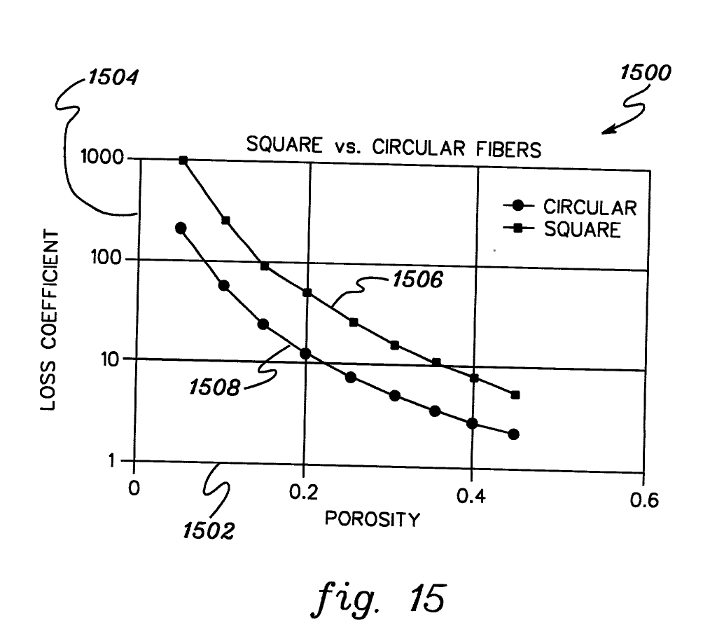

FIG. 15 is a graph 1500 of porosity on the x axis 1502 against the loss coefficient on the y axis 1504 for the example given in the previous paragraph. The graph is derived from Robert D. Blevins, “Applied Fluid Dynamics Handbook,” page 314, Van Nostrand Reinhold Company, 1984, and is reasonably realistic for both air and steam. As shown, the line 1506 for square cross-sectional filaments has a much higher loss coefficient (i.e., flow resistance coefficient) than the line 1508 for round cross-sectional filaments at a given porosity.

In producing graph 1500 for square filaments, a turbulent flow is assumed, leading to a Reynold's number above 400. Based on Table I below, for given porosity, a loss coefficient is provided by Blevins.

TABLE I

| α | K |
|---|---|
| 0 | ∞ |
| 0.05 | 1000 |
| 0.1 | 250 |
| 0.15 | 85 |
| 0.2 | 52 |
| 0.25 | 30 |
| 0.3 | 17 |
| 0.35 | 11 |
| 0.4 | 7.7 |
| 0.45 | 5.5 |

where:
α = porosity; and
K = loss coefficient.

The loss coefficient is calculated according to the formula

$$K = \frac{β ( 1 - {α}^{2} )}{α} ,$$

where βis a function of Reynold's number (see Blevins, Table 10-17, p. 314).

For circular filaments in graph 1500, a Reynolds number above 400 (turbulent flow) was chosen to get β. For a given porosity, then, a loss coefficient can be calculated using the formula noted above. Porosity is given as C/D+C, where C is the distance between filaments and D is the filament diameter. While approximate, the results for circular and square filaments are considered to be acceptable for the porosity range of interest.

While several aspects of the present invention have been described and depicted herein, alternative aspects may be effected by those skilled in the art to accomplish the same objectives. For example, to serve a similar purpose as the labyrinth teeth of FIG. 5 (i.e., as a backer for the filaments), one could add one or more backer rings to the brush seal of the present invention. Such a backer ring would not be used to couple the filaments to the member, since the bonding agent accomplishes that, but only as a support for the filaments. Although a backer would reduce somewhat the achievable seal width for a given geometry, in some applications it may be desirable to prevent over-bending of the filaments from excessive pressure drops, for example. In addition, the invention is applicable anywhere there are members moving relative to each other and a majority (not necessarily all) of a gas or liquid flow is sought to be stopped. As another example, although the brush seal embodiments herein were described as at least one of the members moving relative to the other, the movement is not necessary. At still another example, although several of the embodiments were described with or without one or more grooves into which the flexible filaments are flocked, it will be understood that the grooves are optional in each case. Accordingly, it is intended by the appended claims to cover all such alternative aspects as fall within the true spirit and scope of the invention.

1. A method of creating a brush seal, comprising:
applying a bonding agent to at least one member; and
embedding a plurality of flexible filaments into the bonding agent to create the brush seal.

2. The method of claim 1, further comprising creating at least one groove in the at least one member, and wherein the applying comprises applying the bonding agent within the at least one groove.

3. The method of claim 2, wherein creating the at least one groove comprises creating the at least one groove with at least two different depths.

4. The method of claim 1, wherein the brush seal is installed in a machine between a rotating member and a stationary member, and wherein the at least one member comprises at least one of the rotating member and the stationary member.

5. The method of claim 1, wherein the brush seal is installed in a machine between a first member and a second member, wherein the at least one member comprises at least one of the first member and the second member, and wherein each of the first member and the second member is one of a rotating member and a stationary member.

6. The method of claim 1, wherein applying the bonding agent comprises applying a molten material to the at least one member.

7. The method of claim 6, wherein applying the molten material comprises applying a molten ceramic material.

8. The method of claim 6, wherein applying the molten material comprises applying a molten metal.

9. The method of claim 8, further comprising, prior to applying the molten metal, applying a material in at least one area of the at least one groove where an absence of the plurality of filaments is desired to prevent the molten metal from bonding to the at least one member in the at least one area.

10. The method of claim 1, wherein the plurality of flexible filaments are coated to alter the electrical resistivity thereof.

11. The method of claim 1, wherein applying the bonding agent comprises applying an epoxy to the at least one member.

12. The method of claim 1, wherein applying the bonding agent comprises applying an adhesive to the at least one member.

13. The method of claim 1, wherein applying the bonding agent comprises rotating the at least one member.

14. The method of claim 1, wherein each of the plurality of flexible filaments has an electrical resistivity of about 10⁸ ohms to about 10¹⁰ ohms.

15. The method of claim 1, further comprising repositioning at least some of the plurality of flexible filaments before the bonding agent solidifies.

16. The method of claim 15, wherein repositioning comprises angling the at least some of the plurality of flexible filaments with respect to a normal out of a surface of the at least one member.

17. The method of claim 1, wherein the brush seal is installed on a machine, the method further comprising coupling the at least one member to the machine.

18. The method of claim 17, further comprising creating at least one groove in the machine, and wherein the coupling comprises placing the at least one member in the at least one groove.

19. The method of claim 1, wherein at least one of the plurality of flexible filaments has a non-circular cross-sectional shape.

20. The method of claim 1, wherein at least one of the plurality of flexible filaments has a cross-sectional shape with a flow resistance coefficient lower than that of a circular cross-sectional shape.

21. The method of claim 1, wherein the bonding agent comprises an additive to reduce capillary action.

22. The method of claim 1, wherein the embedding comprises electrostatically flocking.

23. The method of claim 22, wherein the brush seal is installed in a machine between a first member and a second member, wherein the at least one member comprises at least one of the first member and the second member, and wherein the electrostatically flocking comprises electrostatically flocking at least one flexible filament sized longer than a space between the first member and the second member prior to the startup of the machine.

24. A brush seal, comprising:
at least one member;
a bonding agent on a surface of the at least one member;
a plurality of flexible filaments embedded in the bonding agent; and
wherein there is an absence of sealing rings coupling the plurality of flexible filaments to the at least one member.

25. The brush seal of claim 24, wherein the at least one member is part of the machine.

26. The brush seal of claim 25, wherein the at least one member comprises at least one groove, and wherein the bonding agent resides in the groove.

27. The brush seal of claim 26, wherein the at least one groove comprises at least two different depths.

28. The brush seal of claim 25, wherein the brush seal is installed in a machine between a first member and a second member, wherein the at least one member comprises at least one the first member and the second member, and wherein each of the first member and the second member is one of a rotating member and a stationary member.

29. The brush seal of claim 24, wherein the brush seal is for coupling to a machine, and wherein the at least one member is separate from the machine.

30. The seal of claim 29, wherein the machine comprises at least one groove sized to fit the at least one member therein.

31. The brush seal of claim 24, wherein the bonding agent comprises a material with a lower melting point than the plurality of flexible filaments.

32. The brush seal of claim 31, wherein the bonding agent comprises a ceramic material.

33. The brush seal of claim 31, wherein the bonding agent comprises a molten metal.

34. The brush seal of claim 24, wherein the brush seal comprises at least one area having an absence of the plurality of flexible filaments.

35. The brush seal of claim 24, wherein the plurality of flexible filaments are coated to alter the electrical resistivity thereof.

36. The brush seal of claim 24, wherein the bonding agent comprises an additive to reduce capillary action.

37. The brush seal of claim 24, wherein the bonding agent comprises an epoxy.

38. The brush seal of claim 24, wherein the bonding agent comprises an adhesive.

39. The brush seal of claim 24, wherein at least one of the plurality of flexible filaments is angled with respect to a normal out of the member.

40. The brush seal of claim 24, wherein at least one of the plurality of flexible filaments has a non-circular cross-sectional shape.

41. The brush seal of claim 24, wherein at least some of the plurality of flexible filaments are angled.

42. The brush seal of claim 24, further comprising at least one backer on the member for supporting at least some of the plurality of flexible filaments.

43. The brush seal of claim 24, wherein the brush seal is installed in a machine between a first member and a second member, wherein the at least one member comprises at least one of the first member and the second member, and wherein at least one of the plurality of flexible filaments is sized longer than a space between the first member and the second member prior to startup of the machine.

44. The brush seal of claim 24, wherein each of the plurality of flexible filaments has an electrical resistivity of about 10⁸ ohms to about 10¹⁰ ohms.

45. The brush seal of claim 24, wherein at least one of the plurality of flexible filaments has a cross-sectional shape with a flow resistance coefficient lower than that of a circular cross-sectional shape.

46. A system for creating a brush seal, comprising:
a bonding agent for applying to at least one member;
a plurality of flexible filaments; and
a machine for embedding the plurality of flexible filaments into the bonding agent to create the brush seal.

47. The system of claim 46, wherein the bonding agent comprises a molten material.

48. The system of claim 47, wherein the molten material comprises a molten metal.

49. The system of claim 46, wherein the bonding agent comprises an epoxy.

50. The system of claim 46, wherein the bonding agent comprises an adhesive.

51. The system of claim 46, further comprising a material for applying in at least one area of the at least one member on which the bonding agent is to be applied where an absence of the plurality of flexible filaments is desired to prevent the bonding agent from bonding to the at least one member in the at least one area.

52. The system of claim 46, wherein the plurality of flexible filaments are coated to alter the electrical resistivity thereof.

53. The system of claim 46, wherein the bonding agent comprises an additive to reduce capillary action.

54. The system of claim 46, wherein the plurality of flexible filaments comprises at least one flexible filament having a non-circular cross-sectional shape.

55. The system of claim 46, further comprising an angle adjustment tool for angling the plurality of flexible filaments after embedding within the bonding agent and before the applied bonding agent solidifies.

56. The system of claim 46, wherein the machine comprises an electrostatic flocking machine.

57. The system of claim 56, wherein the electrostatic flocking machine comprises:
a flocking gun;
a compressor; and
a hopper for holding the plurality of flexible filaments.

58. The system of claim 57, wherein the electrostatic flocking machine further comprises a power supply for producing a potential difference between the flocking gun and the at least one member.

59. The system of claim 46, wherein each of the plurality of flexible filaments has an electrical resistance of about 10⁸ ohms to about 10¹⁰ ohms.

60. The system of claim 46, wherein at least one of the plurality of flexible filaments has a cross-sectional shape with a flow resistance coefficient higher than that of a circular cross-sectional shape.

61. A brush seal flexible filament having a cross-sectional shape with a flow resistance coefficient higher than that of a circular cross-sectional shape.

62. The brush seal flexible filament of claim 61, wherein the cross-sectional shape comprises one of a square and a star.

63. A brush seal flexible filament having a non-circular cross-sectional shape.

64. The brush seal flexible filament of claim 63, wherein the cross-sectional shape comprises one of a square and a star.

65. A brush seal flexible filament having a cross-sectional shape with at least one of a corner, an included angle, a flat surface and a concave surface.

66. The brush seal flexible filament of claim 65, wherein the cross-sectional shape comprises one of a square and a star.

67. The brush seal flexible filament of claim 65, wherein the cross-sectional shape comprises a corner, and wherein the corner is blunted.

68. The brush seal flexible filament of claim 65, wherein the cross-sectional shape comprises an included angle, and wherein the included angle is blunted.

69. A brush seal flexible filament having a cross-sectional shape allowing more eddy currents to form therearound as compared to a circular cross-sectional shape.

70. The brush seal flexible filament of claim 69, wherein the cross-sectional shape comprises one of a square and a star.
